(19) United States
(12) Patent Application Publication
(10) Pub. No.: US 2026/0100167 A1
(43) Pub. Date: Apr. 9, 2026

(54) SCAN DRIVER, DISPLAY DEVICE, AND ELECTRONIC DEVICE INCLUDING THE SAME

(71) Applicant: Samsung Display Co., Ltd., Yongin-si (KR)

(72) Inventors: Won Jun LEE, Yongin-si (KR); Sung Min SON, Yongin-si (KR); Min Ji KIM, Yongin-si (KR); Geum Ju MOON, Yongin-si (KR)

(21) Appl. No.: 19/274,113

(22) Filed: Jul. 18, 2025

(30) Foreign Application Priority Data
Oct. 7, 2024 (KR) 10-2024-0135831

(51) Int. Cl. G09G 3/3266; G09G 3/32

(52) U.S. Cl. CPC G09G 3/3266; G09G 3/32; G09G 2310/0267; G09G 2310/08

(57) ABSTRACT

A scan driver includes: a plurality of signal pads configured to receive gate control signals from an external source; a phase inversion circuit unit configured to invert the phase of at least one control signal in response to at least one other control signal among the gate control signals supplied through the signal pads, respectively, and to output the control signal having the inverted phase as an output timing signal; and stage circuits configured to sequentially output scan signals to scan signal lines of an image display area based on the output timing signal and at least one of the gate control signals.

### CROSS-REFERENCE TO RELATED APPLICATION

The present application claims priority to and the benefit of Korean Patent Application No. 10-2024-0135831, filed on Oct. 7, 2024, in the Korean Intellectual Property Office, the entire disclosure of which is incorporated herein by reference.

### BACKGROUND

### 1. Field

Aspects of some embodiments of the present disclosure relate to a scan driver, a display device, and an electronic device including the same.

### 2. Description of the Related Art

As the information society develops, consumer demand for display devices for displaying images is increasing in various forms. For example, display devices may be applied to various electronic devices such as smartphones, digital cameras, notebook computers, navigation devices, and smart televisions.

Display devices may include, for example, flat panel display devices such as liquid crystal display devices, quantum dot display devices, and organic light emitting display devices.

A display device includes a display panel which includes data lines, scan signal lines and a plurality of pixels connected to the data lines and the scan signal lines, a scan driver which supplies scan signals to the scan signal lines, a data driver which supplies data voltages to the data lines, and a display driver circuit which controls driving timing of the scan driver and the data driver.

The scan driver may be formed in a non-display area of the display panel. The scan driver sequentially supplies scan signals to the scan signal lines in response to gate control signals from the display driver circuit. The gate control signals from the display driver circuit are transmitted to the scan driver through signal transmission lines and signal pads.

The gate control signals include a gate start signal, a gate selection signal, a plurality of clock pulses having different phases, etc. Because the gate control signals transmitted from the display driver circuit to the scan driver and high-potential and low-potential direct current (DC) voltages are transmitted at different voltage levels, electromagnetic interference occurs between the signal transmission lines as well as between the signal pads. To relatively reduce the electromagnetic interference, dummy pads may additionally placed between the signal pads, and dummy lines may further be placed, or the gap between the signal transmission lines may be arbitrarily widened.

The above information disclosed in this Background section is only for enhancement of understanding of the background and therefore the information discussed in this Background section does not necessarily constitute prior art.

### SUMMARY

Aspects of some embodiments of the present disclosure include a scan driver that may be capable of inverting the phase of at least one of gate control signals generated and transmitted from a display driver circuit and use the signal having the inverted phase as at least one gate control signal and a display device including the scan driver.

Aspects of some embodiments of the present disclosure may include a scan driver that may be capable of rearranging signal pads and signal transmission lines of gate control signals, which include a gate control signal transmitted after its phase is inverted, according to the voltage level or phase of each gate control signal and a display device including the scan driver.

However, aspects of some embodiments according to the present disclosure are not restricted to those specifically set forth herein. The above and other aspects of embodiments according to the present disclosure will become more apparent to one of ordinary skill in the art to which the present disclosure pertains by referencing the detailed description of the present disclosure given below.

According to some embodiments of the present disclosure, a scan driver includes a plurality of signal pads to which gate control signals from an external source are transmitted, a phase inversion circuit unit which inverts the phase of at least one control signal in response to at least one other control signal among the gate control signals supplied through the signal pads, respectively, and outputs the control signal having the inverted phase as an output timing signal, and stage circuits which sequentially output scan signals to scan signal lines of an image display area based on the output timing signal and at least one of the gate control signals.

According to some embodiments of the present disclosure, a display device includes a plurality of pixels which are arranged in a display area of a display panel, a touch sensing unit which is mounted on the front of the display panel and integrally formed with the display panel, a display driver which controls data voltages supplied to the pixels and image display timing of the pixels, and a scan driver which sequentially drives scan signal lines connected to the pixels in response to gate control signals input from the display driver, wherein the scan driver comprises a plurality of signal pads to which the gate control signals are transmitted, a phase inversion circuit unit which inverts the phase of at least one gate control signal in response to at least one other gate control signal among the gate control signals and outputs the gate control signal having the inverted phase as an output timing signal and stage circuits which sequentially output scan signals to the scan signal lines based on the output timing signal and the gate control signals.

According to some embodiments of the present disclosure, an electronic device includes a processor, a memory connected to the processor, and a display device connected to the processor, wherein the display device comprising a plurality of pixels which are arranged in a display area of a display panel, a touch sensing unit which is mounted on the front of the display panel and integrally formed with the display panel, a display driver which controls data voltages supplied to the pixels and image display timing of the pixels and a scan driver which sequentially drives scan signal lines connected to the pixels in response to gate control signals input from the display driver, wherein the scan driver comprises a plurality of signal pads to which the gate control signals are transmitted, a phase inversion circuit unit which inverts the phase of at least one gate control signal in response to at least one other gate control signal among the gate control signals and outputs the gate control signal having the inverted phase as an output timing signal and stage circuits which sequentially output scan signals to the scan signal lines based on the output timing signal and the gate control signals.

In a scan driver and a display device including the same according to some embodiments, the scan driver inverts the phase of at least one of gate control signals received and uses the signal having the inverted phase as at least one gate control signal. Therefore, it may be possible to relatively reduce a difference in voltage level between gate control signals transmitted through adjacent signal pads and signal transmission lines.

Accordingly, the electromagnetic interference between the gate control signals transmitted through the adjacent signal transmission lines can be relatively reduced, and signal distortion and defect occurrence due to the electromagnetic interference can be relatively reduced.

In addition, the signal pads and the signal transmission lines may be rearranged to minimize or reduce the voltage level difference or phase difference between a gate control signal transmitted after its phase is inverted and other gate control signals. Therefore, the number of dummy pads and dummy lines can be reduced or zeroed. In addition, because the number of dummy pads or dummy lines is minimized or reduced, an image non-display area and a bezel area can be relatively reduced.

However, the characteristics of embodiments according to the present disclosure are not restricted to those set forth herein. The above and other characteristics of embodiments according to the present disclosure will become more apparent to one of ordinary skill in the art to which the present disclosure pertains by referencing the claims, and their equivalents.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view of a display device according to an embodiment;

FIG. 2 is a cross-sectional view of the display device according to the embodiment;

FIG. 3 is a plan view of a display unit of the display device according to the embodiment;

FIG. 4 is a block diagram of a display panel and a display driver according to an embodiment;

FIG. 5 is an example diagram of a scan driver according to an embodiment of the present disclosure;

FIG. 6 is a detailed circuit diagram of an embodiment of a phase inversion circuit unit illustrated in FIG. 5;

FIG. 7 is a circuit diagram of a first embodiment of a gate-low signal input/output operation of the phase inversion circuit unit illustrated in FIG. 6;

FIG. 8 is a circuit diagram of a second embodiment of the gate-low signal input/output operation of the phase inversion circuit unit illustrated in FIG. 6;

FIG. 9 is a circuit diagram of a first embodiment of a gate-high signal input/output operation of the phase inversion circuit unit illustrated in FIG. 6;

FIG. 10 is a circuit diagram of a second embodiment of the gate-high signal input/output operation of the phase inversion circuit unit illustrated in FIG. 6;

FIG. 11 is a detailed circuit diagram of an embodiment of an (n−1)^{th} stage circuit of the scan driver illustrated in FIG. 5; and

FIG. 12 is a waveform diagram illustrating changes in the voltage levels of gate control signals, scan clock signals, a pull-up node, and a pull-down node during an active period of an n^{th} frame period.

FIG. 13 is a block diagram of an electronic according to some embodiments.

FIGS. 14, 15 and 16 are schematic diagrams of electronic devices according to some embodiments.

### DETAILED DESCRIPTION

Aspects of some embodiments of the present disclosure will now be described more fully hereinafter with reference to the accompanying drawings, in which non-limiting embodiments of the present disclosure are shown. The present disclosure may, however, be embodied in different forms and should not be construed as limited to the described embodiments set forth herein.

It will also be understood that when a layer is referred to as being “on” another layer or substrate, it can be directly on the other layer or substrate, or intervening layers may also be present. When a layer is referred to as being “directly on” another layer or substrate, no intervening layers may be present.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

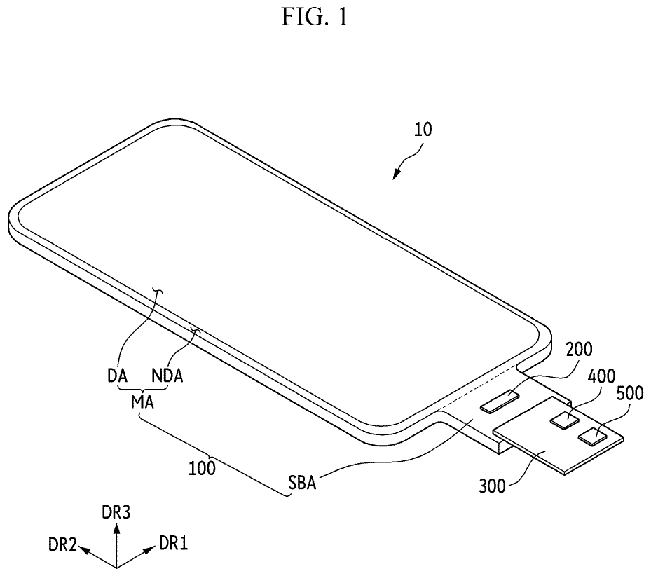

FIG. 1 is a perspective view of a display device 10 according to some embodiments.

Referring to FIG. 1, the display device 10 may be applied to portable electronic devices such as mobile phones, smartphones, tablet personal computers (PCs), mobile communication terminals, electronic notebooks, electronic books, portable multimedia players (PMPs), navigation devices, and ultra-mobile PCs (UMPCs). According to some embodiments, the display device 10 may be applied as a display unit of a television, a notebook computer, a monitor, a billboard, or an Internet of things (IoT) device. According to some embodiments, the display device 10 may be applied to wearable devices such as smart watches, watch phones, glasses-type displays, and head mounted displays (HMDs).

The display device 10 may have a planar shape similar to a quadrilateral. According to some embodiments, the display device 10 may have a planar shape similar to a quadrilateral having short sides in a first direction DR1 and long sides in a second direction DR2. Each corner where a short side extending in the first direction DR1 meets a long side extending in the second direction DR2 may be rounded to have a curvature (e.g., a set or predetermined curvature) or may be right-angled. The planar shape of the display device 10 is not limited to the quadrilateral shape but may also be similar to other polygonal shapes, a circular shape, or an elliptical shape.

The display device 10 may include a display panel 100, a display driver 200, a circuit board 300, a touch driver 400, and a power supply unit 500.

The display panel 100 may include a main area MA and a sub-area SBA.

The main area MA may include a display area DA including pixels that collectively display images and a non-display area NDA arranged around (e.g., in a periphery or outside a footprint of) the display area DA. The display area DA may emit light from a plurality of emission areas or a plurality of opening areas. According to some embodiments, the display panel 100 may include pixel circuits including switching elements, a pixel defining layer defining the emission areas or the opening areas, and self-light emitting elements.

According to some embodiments, each of the self-light emitting elements may include, but is not limited to, at least one of an organic light emitting diode including an organic light emitting layer, a quantum dot light emitting diode including a quantum dot light emitting layer, an inorganic light emitting diode including an inorganic semiconductor, and a micro light emitting diode.

The non-display area NDA may be an area outside the display area DA. The non-display area NDA may be defined as an edge area of the main area MA of the display panel 100. The non-display area NDA may include a gate driver which supplies gate signals to gate lines and fan-out lines which connect the display driver 200 and the display area DA.

The sub-area SBA may extend from a side of the main area MA. The sub-area SBA may include a flexible material that can be bent, folded, rolled, etc. According to some embodiments, when the sub-area SBA is bent, it may be overlapped by the main area MA in a thickness direction (e.g., a third direction DR3). The sub-area SBA may include the display driver 200 and a pad unit connected to the circuit board 300. Optionally, the sub-area SBA may be omitted, and the display driver 200 and the pad unit may be located in the non-display area NDA.

The display driver 200 may output signals and voltages for driving the display panel 100. The display driver 200 may supply data voltages to data lines DL. The display driver 200 may supply a power supply voltage to a power line and supply a gate control signal to a scan driver (or the gate driver). The display driver 200 may be formed as an integrated circuit and mounted on the display panel 100 by a chip on glass (COG) method, a chip on plastic (COP) method, or an ultrasonic bonding method. According to some embodiments, the display driver 200 may be located in the sub-area SBA and may be overlapped by the main area MA in the thickness direction (the third direction DR3) by the bending of the sub-area SBA. According to some embodiments, the display driver 200 may be mounted on the circuit board 300.

The circuit board 300 may be attached onto the pad unit of the display panel 100 using an anisotropic conductive layer. Lead lines of the circuit board 300 may be electrically connected to the pad unit of the display panel 100. The circuit board 300 may be a flexible printed circuit board, a printed circuit board, or a flexible film such as a chip on film.

The touch driver 400 may be mounted on the circuit board 300. The touch driver 400 may be electrically connected to a touch sensing unit of the display panel 100. The touch driver 400 may supply a touch driving signal to a plurality of touch electrodes of the touch sensing unit and sense a change in capacitance between the touch electrodes. According to some embodiments, the touch driving signal may be a pulse signal having a frequency (e.g., a set or predetermined frequency). The touch driver 400 may determine whether an input has been made and calculate coordinates of the input based on a change in capacitance between the touch electrodes. The touch driver 400 may be formed as an integrated circuit.

The power supply unit 500 may be located on the circuit board 300 to supply a power supply voltage to the display driver 200 and the display panel 100. The power supply unit 500 may generate a first driving voltage and supply the first driving voltage to first driving voltage lines VDL, may generate an initialization voltage and supply the initialization voltage to initialization voltage lines VIL, and may generate a common voltage and supply the common voltage to a common electrode common to light emitting elements of a plurality of pixels. According to some embodiments, the first driving voltage may be a high potential voltage for driving the light emitting elements, and each of the common voltage and a second driving voltage may be a low potential voltage for driving the light emitting elements.

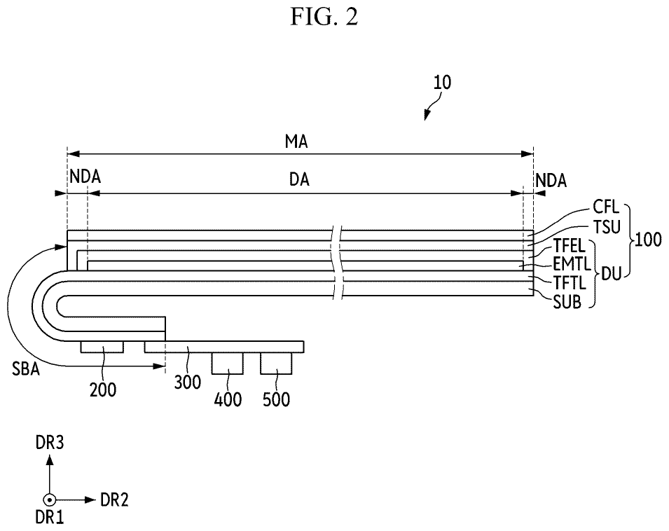

FIG. 2 is a cross-sectional view of the display device 10 according to some embodiments.

Referring to FIG. 2, the display panel 100 may include a display unit DU, a touch sensing unit TSU, and a color filter layer CFL. The display unit DU may include a substrate SUB, a thin-film transistor layer TFTL, a light emitting element layer EMTL, and an encapsulation layer TFEL.

The substrate SUB may be a base substrate or a base member. The substrate SUB may be a flexible substrate that can be bent, folded, rolled, etc. According to some embodiments, the substrate SUB may include polymer resin such as polyimide (PI), but embodiments according to the present disclosure are not limited thereto. According to some embodiments, the substrate SUB may include a glass material or a metal material.

The thin-film transistor layer TFTL may be located on the substrate SUB. The thin-film transistor layer TFTL may include a plurality of thin-film transistors constituting pixel circuits of pixels. The thin-film transistor layer TFTL may further include gate lines, data lines DL, power lines, gate control lines, fan-out lines connecting the display driver 200 and the data lines DL, and lead lines connecting the display driver 200 and a pad unit. Each of the thin-film transistors may include a semiconductor region, a source electrode, a drain electrode, and a gate electrode. According to some embodiments, when the scan driver (e.g., the gate driver) is formed on a side of the non-display area NDA of the display panel 100, it may include thin-film transistors.

The thin-film transistor layer TFTL may be located in the display area DA, the non-display area NDA, and the sub-area SBA. The thin-film transistors of the pixels, the gate lines, the data lines DL, and the power lines of the thin-film transistor layer TFTL may be located in the display area DA. The gate control lines and the fan-out lines of the thin-film transistor layer TFTL may be located in the non-display area NDA. The lead lines of the thin-film transistor layer TFTL may be located in the sub-area SBA.

The light emitting element layer EMTL may be located on the thin-film transistor layer TFTL. The light emitting element layer EMTL may include a plurality of light emitting elements, each including a pixel electrode, a light emitting layer and a common electrode sequentially stacked to emit light, and a pixel defining layer defining the pixels. The light emitting elements of the light emitting element layer EMTL may be located in the display area DA.

The light emitting layer may be an organic light emitting layer including an organic material. The light emitting layer may include a hole transporting layer, an organic light emitting layer, and an electron transporting layer. When the pixel electrode receives a voltage (e.g., a set or predetermined voltage) through a thin-film transistor of the thin-film transistor layer TFTL and the common electrode receives a cathode voltage, holes and electrons may move to the organic light emitting layer through the hole transporting layer and the electron transporting layer, respectively. Then, the holes and the electrons may be combined with each other in the organic light emitting layer to emit light. According to some embodiments, the pixel electrode may be an anode, and the common electrode may be a cathode, but embodiments according to the present disclosure are not limited thereto.

According to some embodiments, each of the light emitting elements may include a quantum dot light emitting diode including a quantum dot light emitting layer, an inorganic light emitting diode including an inorganic semiconductor, or a micro light emitting diode.

The encapsulation layer TFEL may cover upper and side surfaces of the light emitting element layer EMTL and may protect the light emitting element layer EMTL. The encapsulation layer TFEL may include at least one inorganic layer and at least one organic layer to encapsulate the light emitting element layer EMTL.

The touch sensing unit TSU may be located on the encapsulation layer TFEL. The touch sensing unit TSU may include a plurality of touch electrodes for sensing a user's touch in a capacitive manner and touch lines connecting the touch electrodes and the touch driver 400. According to some embodiments, the touch sensing unit TSU may sense a user's touch in a mutual capacitance manner or a self-capacitance manner.

According to some embodiments, the touch sensing unit TSU may be located on a separate substrate located on the display unit DU. In this case, the substrate that supports the touch sensing unit TSU may be a base member that encapsulates the display unit DU.

The touch electrodes of the touch sensing unit TSU may be located in a touch sensor area overlapping the display area DA. The touch lines of the touch sensing unit TSU may be located in a touch peripheral area overlapping the non-display area NDA.

The color filter layer CFL may be located on the touch sensing unit TSU. The color filter layer CFL may include a plurality of color filters corresponding to a plurality of emission areas, respectively. Each of the color filters may selectively transmit light of a specific wavelength and block or absorb light of other wavelengths. The color filter layer CFL may absorb a part of light coming from the outside of the display device 10, thereby relatively reducing reflected light caused by the external light. Therefore, the color filter layer CFL can prevent or reduce color distortion caused by reflection of external light.

Because the color filter layer CFL is directly located on the touch sensing unit TSU, the display device 10 may not require a separate substrate for the color filter layer CFL. Therefore, a thickness of the display device 10 can be relatively reduced.

The sub-area SBA of the display panel 100 may extend from a side of the main area MA. The sub-area SBA may include a flexible material that can be bent, folded, rolled, etc. According to some embodiments, when the sub-area SBA is bent, it may be overlapped by the main area MA in the thickness direction (the third direction DR3). The sub-area SBA may include the display driver 200 and the pad unit electrically connected to the circuit board 300.

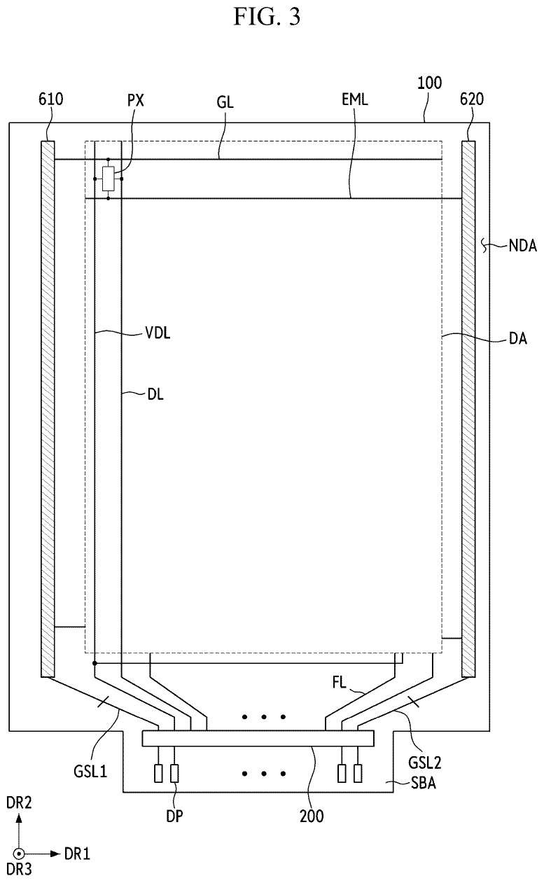

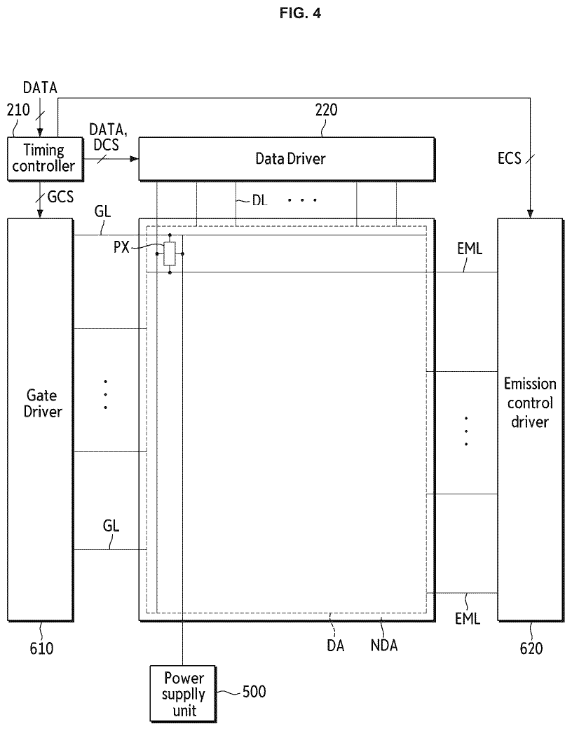

FIG. 3 is a plan view of the display unit DU of the display device 10 according to some embodiments. FIG. 4 is a block diagram of the display panel 100 and the display driver 200 according to some embodiments.

Referring to FIGS. 3 and 4, the display panel 100 may include the display area DA and the non-display area NDA.

The display area DA may include a plurality of pixels PX and a plurality of first driving voltage lines VDL, a plurality of second driving voltage lines, a plurality of gate lines GL, a plurality of emission control lines EML and a plurality of data lines DL connected to the pixels PX.

Each of the pixels PX may be connected to a gate line GL, a data line DL, an emission control line EML, a first driving voltage line VDL, and a second driving voltage line. Each of the pixels PX may include at least one thin-film transistor, a light emitting element, and a capacitor.

The gate lines GL may extend in the first direction DR1 and may be spaced apart from each other in the second direction DR2 intersecting the first direction DR1. The gate lines GL may be arranged along the second direction DR2. The gate lines GL may sequentially supply gate signals to the pixels PX arranged in the first or second direction DR1 or DR2.

The emission control lines EML may extend in the first direction DR1 and may be spaced apart from each other in the second direction DR2. The emission control lines EML may be arranged along the second direction DR2. The emission control lines EML may sequentially supply emission timing signals to the pixels PX arranged in the first or second direction DR1 or DR2.

The data lines DL may extend in the second direction DR2 and may be spaced apart from each other in the first direction DR1. The data lines DL may be arranged along the first direction DR1. The data lines DL may sequentially supply a data voltage to the pixels PX arranged in the second direction DR2. The data voltage may determine the luminance of each of the pixels PX.

The first driving voltage lines VDL may extend in the second direction DR2 and may be spaced apart from each other in the first direction DR1. The first driving voltage lines VDL may be arranged along the first direction DR1. The first driving voltage lines VDL may supply a first driving voltage to the pixels PX. The first driving voltage may be a high potential voltage for driving the light emitting elements of the pixels PX. In addition, the second driving voltage lines may be further formed to supply a second driving voltage, which is a low potential voltage, to the pixels PX.

The non-display area NDA may surround the display area DA. The non-display area NDA may include a scan driver 610, an emission control driver 620, fan-out lines FL, first gate control lines GSL1, and second gate control lines GSL2.

The fan-out lines FL may extend from the display driver 200 to the display area DA. The fan-out lines FL may supply data voltages received from the display driver 200 to the data lines DL.

The first gate control lines GSL1 may extend from signal pads of the display driver 200 to signal terminals of the scan driver 610. The first gate control lines GSL1 may supply first gate control signals GCS1 received from the display driver 200 through the signal pads to the signal terminals of the scan driver 610.

The second gate control lines GSL2 may extend from signal pads of the display driver 200 to signal terminals of the emission control driver 620. The second gate control lines GSL2 may supply emission control signals ECS received from the display driver 200 through the signal pads to the signal terminals of the emission control driver 620.

The sub-area SBA may extend from a side of the non-display area NDA. The sub-area SBA may include the display driver 200 and a pad unit DP. The pad unit DP may be located closer to an edge of the sub-area SBA than the display driver 200. The pad unit DP may be electrically connected to the circuit board 300 through an anisotropic conductive layer.

Referring to FIG. 4, the display driver 200 may include a timing controller 210 and a data driver 220.

The timing controller 210 may receive digital video data DATA and timing signals (e.g., vertical and horizontal synchronization signals, a dot clock, etc.) from the circuit board 300. The timing controller 210 may control the operation timing of the data driver 220 by generating a data control signal DCS based on the timing signals, may control the operation timing of the scan driver 610 by generating the gate control signals GCS, and may control the operation timing of the emission control driver 620 by generating the emission control signals ECS.

The timing controller 210 may invert the phase of at least one of the gate control signals GCS and transmit the gate control signal GCS having the inverted phase to the scan driver 610. In addition, the timing controller 210 may invert the phase of at least one of the emission control signals ECS and transmit the emission control signal ECS having the inverted phase to the emission control driver 620.

The timing controller 210 may supply the gate control signals GCS to the scan driver 610 through signal pads and the first gate control lines GSL1. In addition, the timing controller 210 may supply the emission control signals ECS to the emission control driver 620 through signal pads and the second gate control lines GSL2.

The timing controller 210 may supply the digital video data DATA and the data control signals DCS to the data driver 220. At this time, the timing controller 210 may invert the phase of at least one of the data control signals DCS and transmit the data control signal DCS having the inverted phase to the data driver 220.

The data driver 220 may convert the digital video data DATA into analog data voltages and supply the analog data voltages to the data lines DL through the fan-out lines FL. Gate signals of the scan driver 610 may select pixels PX to which the data voltages are to be supplied, and the selected pixels PX may receive the data voltages through the data lines DL.

The power supply unit 500 may be located on the circuit board 300 to supply a power supply voltage to the display driver 200 and the display panel 100. The power supply unit 500 generates a high-potential first driving voltage and supplies the first driving voltage to the first driving voltage lines VDL and generates a low-potential second driving voltage and supplies the second driving voltage to the second driving voltage lines. In addition, the power supply unit 500 may generate an initialization voltage and supply the initialization voltage to initialization voltage lines and may generate a common voltage and supply the common voltage to a common electrode common to the light emitting elements of the pixels PX.

The scan driver 610 may be located outside one side of the display area DA or on one side of the non-display area NDA, and the emission control driver 620 may be located outside the other side of the display area DA or on the other side of the non-display area NDA. However, embodiments according to the present disclosure are not limited thereto. According to some embodiments, the scan driver 610 and the emission control driver 620 may be located on either one side or the other side of the non-display area NDA.

The scan driver 610 may include a phase inversion circuit unit which inverts the phase of at least one of the gate control signals GCS and a plurality of stage circuits which sequentially generate gate signals using the gate control signal having the inverted phase and the other gate control signals GCS. The phase inversion circuit unit and the stage circuits are formed to include a plurality of thin-film transistors (hereinafter, referred to as transistors).

The emission control driver 620 may include a plurality of transistors which generate emission timing signals based on the emission control signals ECS.

The emission control driver 620 may also include a phase inversion circuit unit which inverts the phase of at least one of the emission control signals ECS and a plurality of stage circuit units which sequentially generate emission timing signals using the emission control signal having the inverted phase and the other emission control signals ECS. The phase inversion circuit unit and the stage circuits are formed to include a plurality of transistors.

The transistors of the scan driver 610 and the transistors of the emission control driver 620 may be formed in the thin-film transistor layer TFTL, like the transistors included in the pixels PX. The scan driver 610 may supply gate signals to the gate lines GL, and the emission control driver 620 may supply emission timing signals to the emission control lines EML.

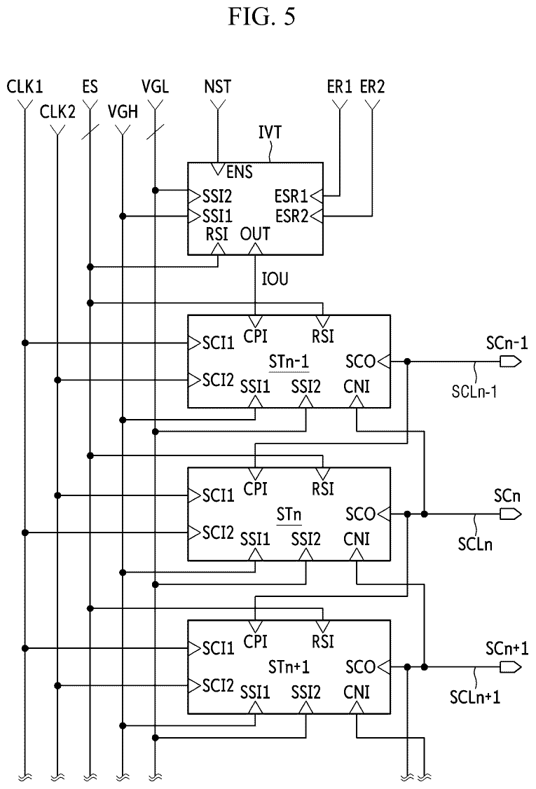

FIG. 5 is an example diagram of a scan driver 610 according to some embodiments of the present disclosure.

Referring to FIG. 5, the scan driver 610 according to some embodiments includes at least one phase inversion circuit unit IVT and a plurality of stage circuits STn−1 through STn+1 dependently connected to each other.

The at least one phase inversion circuit unit IVT inverts the phase of at least one of the gate control signals GCS and supplies the gate control signal having the inverted phase to at least one stage circuit STn−1.

According to some embodiments, the phase inversion circuit unit IVT inverts the phase of at least one gate control signal in response to at least one other gate control signal among the gate control signals GCS and supplies the gate control signal having the inverted phase to at least one stage circuit STn−1.

The timing controller 210 of the display driver 200 supplies a plurality of gate control signals GCS including an output timing signal NST such as a start signal, a line selection signal ES, a plurality of scan clock signals CLK1 and CLK2 having different phases, reset control signals and first and second inversion signals ER1 and ER2 to the scan driver 610. In addition, a first driving voltage VGH and a second driving voltage VGL from the power supply unit 500 are supplied to the scan driver 610.

The phase inversion circuit unit IVT of the scan driver 610 inverts the phase of the output timing signal NST such as a start signal in response to the first and second inversion signals ER1 and ER2 among the gate control signals GCS. Then, the output timing signal NST having the inverted phase may be supplied as a start timing signal IOU to at least one of the stage circuits STn−1 through STn+1.

The stage circuits STn−1 through STn+1 are dependently connected to each other and sequentially output scan signals to the gate lines GL, respectively. Here, nis a positive integer.

In FIG. 5, for ease of description, only (n−1)^{th} through (n+1)^{th} stage circuits STn−1 through STn+1 are illustrated based on an n^{th} stage circuit STn.

In the following description, a “previous stage circuit” refers to a stage circuit located in front of the n^{th} stage circuit STn. A “next stage circuit” refers to a stage circuit located behind the n^{th} stage circuit STn. According to some embodiments, a previous stage circuit of the n^{th} stage circuit STn refers to the (n−1)^{th} stage circuit STn−1, and a next stage circuit of the n^{th} stage circuit STn refers to the (n+1)^{th} stage circuit STn+1.

Scan clock lines and gate control lines GSL may be located on one side of the (n−1)^{th} through (n+1)^{th} stage circuits STn−1 through STn+1. A plurality of scan clock signals CLK1 and CLK2 whose phases are sequentially delayed or sequentially alternated are transmitted to the scan clock lines, respectively, and the line selection signal ES and a reset signal are transmitted to the gate control lines GSL, respectively. At least one of the (n−1)^{th} through (n+1)^{th} stage circuits STn−1 through STn+1 receives the start timing signal IOU whose phase has been inverted through the phase inversion circuit unit IVT.

As described above, the scan clock signals CLK1 and CLK2, the line selection signal ES, the output timing signal NST, the reset control signals, and the first and second inversion signals ER1 and ER2 may be the gate control signals GCS generated from the display driver 200 and transmitted through the first gate control lines GSL1. In FIG. 5, two scan clock lines, two sensing control lines, two inversion signal lines, and two power lines are illustrated as the first gate control lines GSL1. However, the number of scan clock lines and sensing control lines is not limited thereto.

The scan driver 610 includes the (n−1)^{th} through (n+1)^{th} stage circuits STn−1 through STn+1 connected to the first gate control lines GSL1, respectively. Here, n is a positive integer. Among n^{th} stage circuits STn, the (n−1)^{th} stage circuit STn−1 may output an (n−1)^{th} scan signal SCn−1 to an (n−1)^{th} scan signal line SCLn−1, and the n^{th} stage circuit STn may output an n^{th} scan signal SCn to an n^{th} scan signal line SCLn. Accordingly, the (n+1)^{th} stage circuit STn+1 outputs an (n+1)^{th} scan signal SCn+1 to an (n+1)^{th} scan signal line SCLn+1.

Each of the (n−1)^{th} through (n+1)^{th} stage circuits STn−1 through STn+1 includes a previous carry terminal CPI, a next carry terminal CNI, a first scan clock terminal SCI1, a second scan clock terminal SCI2, a first power supply terminal SSI1, a second power supply terminal SSI2, a sensing signal terminal RSI, and a scan output terminal SCO.

When the (n−1)^{th} stage circuit STn−1 is a first stage circuit, the output timing signal NST whose phase has been inverted by the phase inversion circuit unit IVT may be input as the start timing signal IOU to the previous carry terminal CPI of the (n−1)^{th} stage circuit STn−1 through a start timing line.

The previous carry terminal CPI of each of the stage circuits dependently connected after the first stage circuit may be connected to the scan output terminal SCO of an immediately previous stage circuit. According to some embodiments, as illustrated in FIG. 5, the previous carry terminal CPI of the n^{th} stage circuit STn may be connected to the scan output terminal SCO of the (n−1)^{th} stage circuit STn−1.

The next carry terminal CNI of each of the (n−1)^{th} through (n+1)^{th} stage circuits STn−1 through STn+1 may be connected to the scan output terminal SCO of any one next stage circuit. According to some embodiments, as illustrated in FIG. 5, the next carry terminal CNI of the n^{th} stage circuit STn may be connected to the scan output terminal SCO of the (n+1)^{th} stage circuit STn+1 and may receive the scan signal SCn+1 of the (n+1)^{th} stage circuit STn+1 as a next carry signal.

The scan output terminals SCO of the (n−1)^{th} through (n+1)^{th} stage circuits STn−1 through STn+1 are sequentially connected to corresponding gate lines GL, that is, scan signal lines SCL, respectively. Accordingly, the scan signal lines SCL may be connected one-to-one to the scan output terminals SCO of the stage circuits STn−1 through STn+1. According to some embodiments, the (n−1)^{th} scan signal line SCLn−1 is connected to the scan output terminal SCO of the (n−1)^{th} stage circuit STn−1, and the n^{th} scan signal line SCLn is connected to the scan output terminal SCO of the n^{th} stage circuit STn. In addition, the (n+1)^{th} scan signal line SCLn+1 may be connected to the scan output terminal SCO of the (n+1)^{th} stage circuit STn+1.

The sensing signal terminal RSI of each of the (n−1)^{th} through (n+1)^{th} stage circuits STn−1 through STn+1 receives the line selection signal ES through a sensing control line to which the line selection signal ES is transmitted.

Each of the (n−1)^{th} through (n+1)^{th} stage circuits STn−1 through STn+1 receives two scan clock signals, that is, the first and second scan clock signals CLK1 and CLK2 whose phases are sequentially alternated or delayed through the first scan clock terminal SCI1 and the second scan clock terminal SCI2.

According to some embodiments, each of the (n−1)^{th} through (n+1)^{th} stage circuits STn−1 through STn+1 may receive the first scan clock signal CLK1 through the first scan clock terminal SCI1 and receive the second scan clock signal CLK2, whose phase is sequentially alternated or delayed from that of the first scan clock signal CLK1, through the second scan clock terminal SCI2.

The (n−1)^{th} through (n+1)^{th} stage circuits STn−1 through STn+1 sequentially output the scan signals SCn−1 through SCn+1 to the scan signal lines SCLn−1 through SCLn+1 connected one-to-one thereto through their respective scan output terminals SCO, respectively. According to some embodiments, during at least one frame period, the (n−1)^{th} stage circuit STn−1 outputs the (n−1)^{th} scan signal SCn−1 to the (n−1)^{th} scan signal line SCLn−1 connected to the scan output terminal SCO. Next, the n^{th} stage circuit STn outputs the n^{th} scan signal SCn to the n^{th} scan signal line SCLn connected to the scan output terminal SCO. Accordingly, the (n+1)^{th} stage circuit STn+1 may output the (n+1)^{th} scan signal SCn+1 to the (n+1)^{th} scan signal line SCLn+1 connected to the scan output terminal SCO.

The emission control driver 620 which sequentially generates and outputs emission signals in response to the emission control signals ECS received from the display driver 200 may also be structured to include the phase inversion circuit unit IVT and the (n−1)^{th} through (n+1)^{th} stage circuits STn−1 through STn+1, that is, the n^{th} stage circuits STn. Therefore, a description of the detailed structure of the emission control driver 620 will be replaced with the description of the scan driver 610.

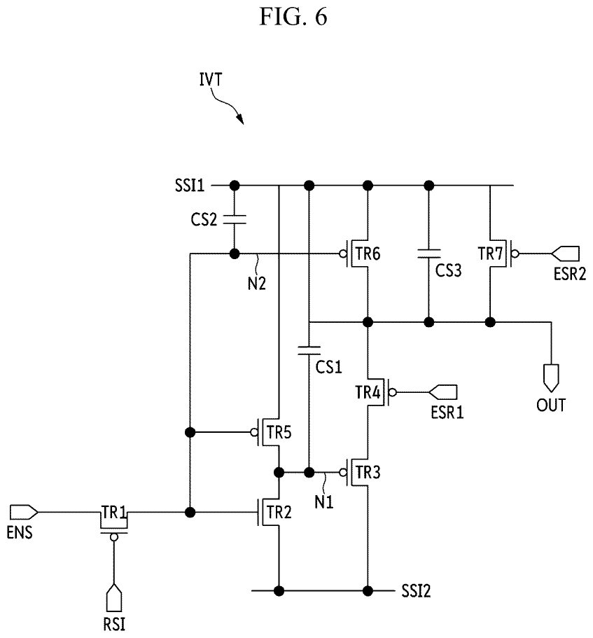

FIG. 6 is a detailed circuit diagram illustrating aspects of the phase inversion circuit unit IVT illustrated in FIG. 5 according to some embodiments. Although FIG. 6 illustrates various components in a phase inversion circuit unit according to some embodiments, embodiments according to the present disclosure are not limited thereto, and according to various embodiments, the phase inversion circuit unit may include additional components or fewer components without departing from the spirit and scope of embodiments according to the present disclosure.

Referring to FIG. 6, the phase inversion circuit unit IVT includes a timing control terminal ENS connected to a timing control line, a sensing signal terminal RSI, first and second inversion control terminals ESR1 and ESR2, and a timing signal output terminal OUT. In addition, the phase inversion circuit unit IVT further includes a first power supply terminal SSI1 to which a gate-off voltage (e.g., a high-potential direct current (DC) voltage) is supplied and a second power supply terminal SSI2 to which a gate-on voltage (e.g., a low-potential DC voltage) is supplied.

The phase inversion circuit unit IVT inverts the phase of the output timing signal NST input to the timing control terminal ENS in response to the line selection signal ES input to the sensing signal terminal RSI and the first and second inversion signals ER1 and ER2 input to the first and second inversion control terminals ESR1 and ESR2. In addition, the start timing signal IOU whose phase has been inverted is transmitted to at least any one of the (n−1)^{th} through (n+1)^{th} stage circuits STn−1 through STn+1 through the timing signal output terminal OUT.

According to some embodiments, the phase inversion circuit unit IVT may include first through seventh switching elements TR1 through TR7 and first through third capacitors CS1 through CS3.

The first switching element TR1 is turned on or off in response to the line selection signal ES input to the sensing signal terminal RSI and outputs or blocks the output timing signal NST input to the timing control terminal ENS.

The second switching element TR2 is turned on or off in response to the output timing signal NST input through the first switching element TR1 and supplies the second driving voltage VGL at the level of the gate-on voltage to a first control node N1 or blocks the second driving voltage VGL.

The third switching element TR3 is turned on or off in response to the second driving voltage VGL at the level of the gate-on voltage level to the first control node N1 and outputs or blocks the second driving voltage VGL.

The fourth switching element TR4 is turned on or off in response to the first inversion signal ER1 input to the first inversion control terminal ESR1 and outputs the second driving voltage VGL input through the third switching element TR3 to the timing signal output terminal OUT or blocks the second driving voltage VGL.

The fifth switching element TR5 is turned on or off in response to a voltage level of the output timing signal NST input through the first switching element TR1 and supplies the first driving voltage VGH at the level of the gate-off voltage to the first control node N1 or blocks the first driving voltage VGH.

The sixth switching element TR6 is turned on or off in response to the voltage level of the output timing signal NST input to a second control node N2 through the first switching element TR1 and outputs the first driving voltage VGH at the level of the gate-off voltage to the timing signal output terminal OUT or blocks the first driving voltage VGH.

The seventh switching element TR7 is turned on or off in response to the second inversion signal ER2 input to the second inversion control terminal ESR2 and outputs the first driving voltage VGH to the timing signal output terminal OUT or blocks the first driving voltage VGH.

The first and third through seventh switching elements TR1 and TR3 through TR7 may all be formed as n-channel metal oxide semiconductor (NMOS) transistors of the same type, and the second switching element TR2 may be formed as a p-channel metal oxide semiconductor (PMOS) transistor of a different type from the first and third through seventh switching elements TR1 and TR3 through TR7. Alternatively, the first and third through seventh switching elements TR1 and TR3 through TR7 may all be formed as PMOS transistors of the same type, and the second switching element TR2 may be formed as an NMOS transistor of a different type from the first and third through seventh switching elements TR1 and TR3 through TR7.

The first capacitor CS1 may be electrically connected between the first control node N1 and the first power supply terminal SSI1 to which the first driving voltage VGH at the level of the gate-off voltage is applied.

The second capacitor CS2 may be electrically connected between the second control node N2 and the first power supply terminal SSI1 to which the first driving voltage VGH is applied.

The third capacitor CS3 may be electrically connected between the timing signal output terminal OUT and the first power supply terminal SSI1.

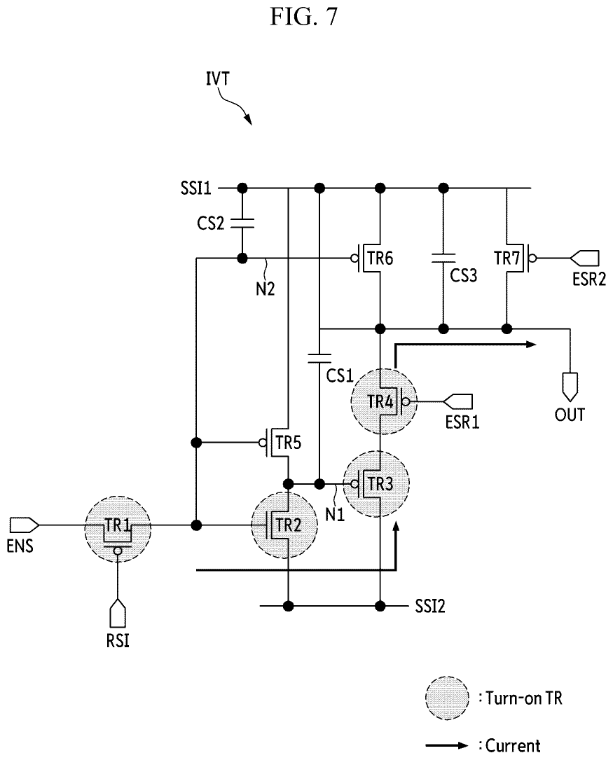

FIG. 7 is a circuit diagram illustrating aspects of a gate-low signal input/output operation of the phase inversion circuit unit IVT illustrated in FIG. 6.

Table 1 below shows voltage levels of the output timing signal NST, the line selection signal ES and the first inversion signal ER1 respectively input to the timing control terminal ENS, the sensing signal terminal RSI and the first inversion control terminal ESR1 of the phase inversion circuit unit IVT and a voltage level of a signal output to the timing signal output terminal OUT. In addition, Table 1 shows turn-on/off states of the first through fourth switching elements TR1 through TR4.

TABLE 1

| | |
|---|---|
| ENS | VGH |
| RSI (ES) | VGL (gate on) |
| TR1 | Turn-on |
| TR2 | Turn-on |
| TR3 | Turn-on |
| ESR1 | VGL (gate on) |
| TR4 | Turn-on |
| OUT | VGL |

For example, Table 1 shows voltage levels of input/output signals during a phase inversion output period of the phase inversion circuit unit IVT, that is, a period in which the phase inversion circuit unit IVT inverts the phase of the output timing signal NST at the level of a gate-high voltage, which is input to the timing control terminal ENS, to the level of a gate-low voltage and then outputs the output timing signal NST at the level of the gate-low voltage.

According to some embodiments, the output timing signal NST input to the timing control terminal ENS may be used as a start signal that sets the start timing of the (n−1)^{th} through (n+1)^{th} stage circuits STn−1 through STn+1. That is, the output timing signal NST input to the timing control terminal ENS may be a start signal that is generated and output in an opposite phase by the display driver 200. In this case, the phase inversion circuit unit IVT may invert the phase of the output timing signal NST transmitted and input in the opposite phase and supply the output timing signal NST having the inverted phase to the first stage circuit (e.g., the (n−1)^{th} stage circuit STn−1) as a start signal.

Referring to Table 1 together with FIG. 7, during the phase inversion output period of the output timing signal NST, the first switching element TR1 is turned on in response to the line selection signal ES at the level of a gate-on voltage input to the sensing signal terminal RSI and outputs the output timing signal NST at the level of the gate-high voltage, which is input to the timing control terminal ENS, to a gate terminal of the second switching element TR2.

During a period in which the output timing signal NST at the level of the gate-high voltage is output to the gate terminal of the second switching element TR2, the output timing signal NST at the level of the gate-high voltage is also supplied to a terminal of the second capacitor CS2. Accordingly, the second capacitor CS2 performs a charging operation according to the voltage level of the output timing signal NST.

The second switching element TR2 is turned on in response to the output timing signal NST at the level of the gate-high voltage input through the first switching element TR1 and supplies the second driving voltage VGL at the level of the gate-on voltage (or the gate-low voltage) to the first control node N1.

The third switching element TR3 is turned on in response to the second driving voltage VGL at the level of the gate-on voltage applied to the first control node N1 and outputs the second driving voltage VGL at the level of the gate-on voltage (or the gate-low voltage) to an input terminal (e.g., a drain terminal) of the fourth switching element TR4.

The fourth switching element TR4 is turned on in response to the first inversion signal ER1 at the level of the gate-on voltage input to the first inversion control terminal ESR1. Accordingly, the second driving voltage VGL at the level of the gate-on voltage (or the gate-low voltage) input from the third switching element TR3 to the fourth switching element TR4 is output to the timing signal output terminal OUT.

In this way, during the phase inversion output period of the output timing signal NST, the phase inversion circuit unit IVT outputs the second driving voltage VGL, whose phase is opposite to the phase of the output timing signal NST, to the timing signal output terminal OUT in response to the line selection signal ES and the first inversion signal ER1.

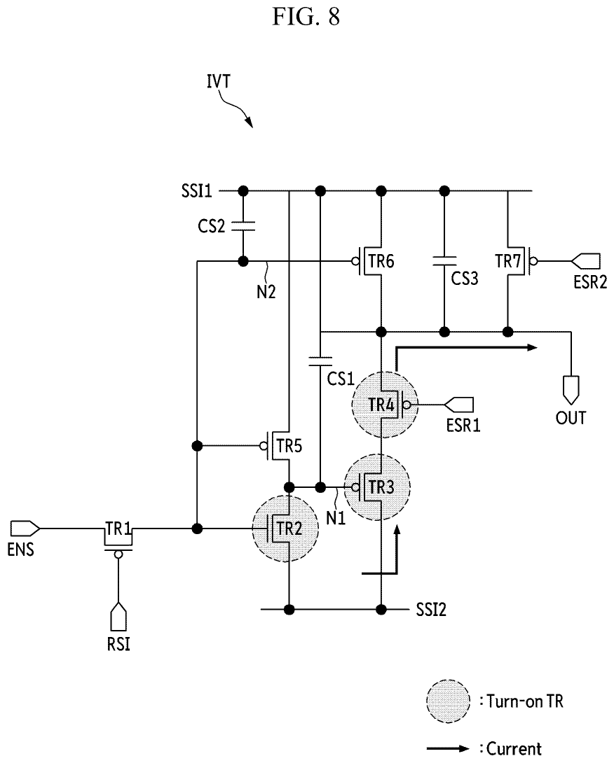

FIG. 8 is a circuit diagram of a second embodiment of the gate-low signal input/output operation of the phase inversion circuit unit IV illustrated in FIG. 6.

Table 2 below shows a state in which the voltage level of the first inversion signal ER1 (or the line selection signal ES) input to the sensing signal terminal RSI is changed to the level of a gate-off voltage (e.g., the gate-high voltage) during the phase inversion output period of the phase inversion circuit unit IVT, which is different from Table 1.

TABLE 2

| | |
|---|---|
| ENS | VGH/VGL |
| RSI (ES) | VGH (gate off) |
| TR1 | Turn-off |
| TR2 | Turn-on |
| TR3 | Turn-on |
| ESR1 | VGL (gate on) |
| TR4 | Turn-on |
| OUT | VGL |

As shown in Table 2, the voltage level of the line selection signal ES input to the sensing signal terminal RSI may be changed to the level of the gate-off voltage.

As the voltage level of the line selection signal ES is changed to the level of the gate-off voltage, the first switching element TR1 is turned off.

When the first switching element TR1 is turned off, a voltage difference occurs between the first power supply terminal SSI1 and an output terminal of the first switching element TR1. Therefore, the second capacitor CS2 discharges a charge voltage toward a gate electrode of the second switching element TR2. Accordingly, the second switching element TR2 is kept turned on by the level of the gate-high voltage discharged from the second capacitor CS2 and supplies the second driving voltage VGL at the level of the gate-on voltage to the first control node N1.

The third switching element TR3 is kept turned on by the second driving voltage VGL at the level of the gate-on voltage (or the gate-low voltage) applied to the first control node N1 and outputs the second driving voltage VGL to the input terminal of the fourth switching element TR4.

Similarly, the fourth switching element TR4 is kept turned on by the voltage level of the first inversion signal ER1 and allows the second driving voltage VGL at the level of the gate-on voltage (or the gate-low voltage) to be output to the timing signal output terminal OUT.

In this way, the phase inversion circuit unit IVT may output the second driving voltage VGL, whose phase is opposite to the phase of the output timing signal NST, to the timing signal output terminal OUT even if the phase of the line selection signal ES is inverted and changed.

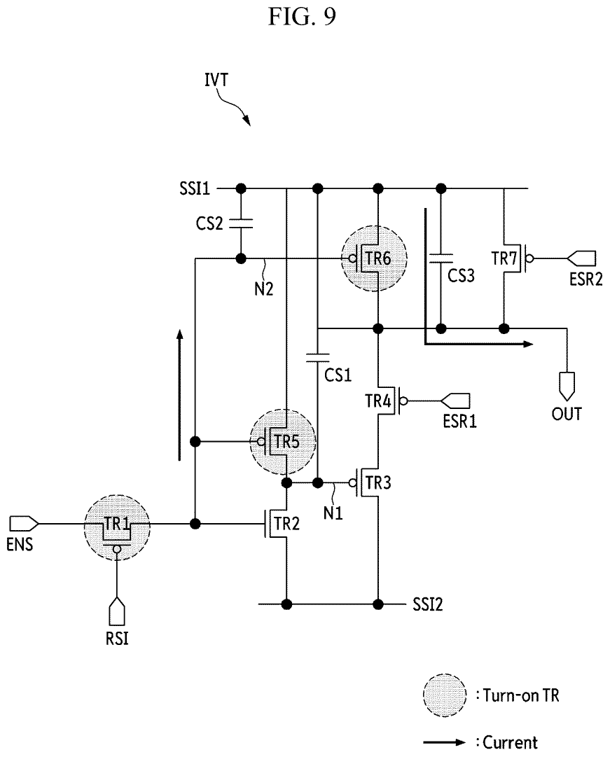

FIG. 9 is a circuit diagram of a first embodiment of a gate-high signal input/output operation of the phase inversion circuit unit IVT illustrated in FIG. 6.

Table 3 below shows voltage levels of the output timing signal NST, the line selection signal ES and the second inversion signal ER2 respectively input to the timing control terminal ENS, the sensing signal terminal RSI and the second inversion control terminal ESR2 of the phase inversion circuit unit IVT and a voltage level of a signal output to the timing signal output terminal OUT. In addition, Table 3 shows turn-on/off states of the first, fifth and sixth switching elements TR1, TR5 and TR6.

TABLE 3

| | |
|---|---|
| ENS | VGL |
| RSI (ES) | VGL (gate on) |
| TR1 | Turn-on |
| TR5 | Turn-on |
| TR6 | Turn-on |
| ESR 2 | VGL (gate on) |
| TR4 | Turn-on |
| OUT | VGH |

For example, Table 3 shows voltage levels of input/output signals during a period in which the phase inversion circuit unit IVT inverts the phase of the output timing signal NST at the level of a gate-low voltage, which is input to the timing control terminal ENS, to the level of a gate-high voltage and then outputs the output timing signal NST at the level of the gate-high voltage.

Referring to Table 3 together with FIG. 9, the first switching element TR1 is turned on in response to the line selection signal ES at the level of a gate-on voltage input to the sensing signal terminal RSI and outputs the output timing signal NST at the level of the gate-low voltage, which is input to the timing control terminal ENS, to gate terminals of the second, fifth and sixth switching elements TR2, TR5 and TR6.

The second capacitor CS2 may be kept discharged by the output timing signal NST at the level of the gate-low voltage.

The second switching element TR2 is turned off by the output timing signal NST at the level of the gate-low voltage input through the first switching element TR1, and the fifth and sixth switching elements TR5 and TR6 are turned on by the output timing signal NST.

The fifth switching element TR5 is turned on by the output timing signal NST and supplies the first driving voltage VGH at the level of a gate-off voltage (or the gate-high voltage) to the first control node N1. Accordingly, the third switching element TR3 is turned off.

On the other hand, the sixth switching element TR6 is turned on by the output timing signal NST and allows the first driving voltage VGH at the level of the gate-off voltage (or the gate-high voltage) to be output to the timing signal output terminal OUT.

The second capacitor CS2 maintains the level of the first driving voltage VGH output to the timing signal output terminal OUT.

The seventh switching element TR7 may also be turned on in response to the second inversion signal ER2 at the level of the gate-on voltage input to the second inversion control terminal ESR2. The seventh switching element TR7 may allow the first driving voltage VGH at the level of the gate-off voltage (or the gate-high voltage) to be output to the timing signal output terminal OUT.

In this way, the phase inversion circuit unit IVT may output the first driving voltage VGH, whose phase is opposite to the phase of the output timing signal NST, to the timing signal output terminal OUT in response to the line selection signal ES and the second inversion signal ER2.

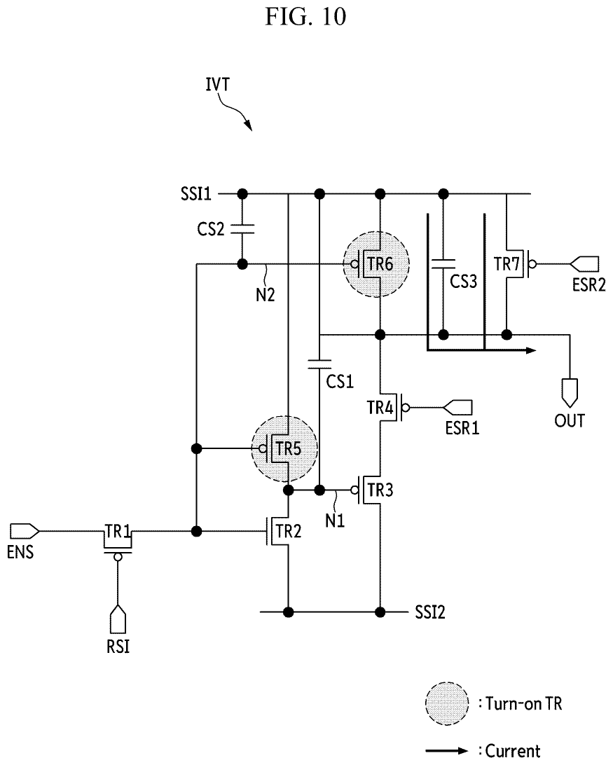

FIG. 10 is a circuit diagram of a second embodiment of the gate-high signal input/output operation of the phase inversion circuit unit IVT illustrated in FIG. 6.

Table 4 below shows a state in which the voltage level of the line selection signal ES input to the sensing signal terminal RSI is changed to the level of a gate-off voltage (e.g., the gate-high voltage) during the phase inversion output period of the phase inversion circuit unit IVT, which is different from Table 3.

TABLE 4

| | |
|---|---|
| ENS | VGH/VGL |
| RSI (ES) | VGH (gate off) |
| TR1 | Turn-off |
| TR5 | Turn-on |
| TR6 | Turn-on |
| ESR2 | VGL (gate on) |
| TR4 | Turn-off |
| OUT | VGH |

As shown in Table 4, the voltage level of the line selection signal ES input to the sensing signal terminal RSI may be changed to the level of the gate-off voltage.

As the voltage level of the line selection signal ES is changed to the level of the gate-off voltage, the first switching element TR1 is turned off.

When the first switching element TR1 is turned off, the second capacitor CS2 is kept discharged. Accordingly, the second control node N2 is maintained at the level of the gate-low voltage (or the gate-on voltage).

As the second control node N2 is maintained at the level of the gate-on voltage, the fifth switching element TR5 is kept turned on and supplies the first driving voltage VGH at the level of the gate-off voltage (or the gate-high voltage) to the first control node N1. Accordingly, the third switching element TR3 is kept turned off.

Similarly, as the second control node N2 is maintained at the level of the gate-on voltage, the sixth switching element TR6 is also kept turned on and allows the first driving voltage VGH at the level of the gate-off voltage (or the gate-high voltage) to be output to the timing signal output terminal OUT.

The second capacitor CS2 maintains the level of the first driving voltage VGH output to the timing signal output terminal OUT.

The seventh switching element TR7 may also be kept turned on by the second inversion signal ER2 at the level of the gate-on voltage input to the second inversion control terminal ESR2. The seventh switching element TR7 may allow the first driving voltage VGH at the level of the gate-off voltage (or the gate-high voltage) to be output to the timing signal output terminal OUT. In this way, the phase inversion circuit unit IVT may output the first driving voltage VGH, whose phase is opposite to the phase of the output timing signal NST, to the timing signal output terminal OUT in response to the second inversion signal ER2.

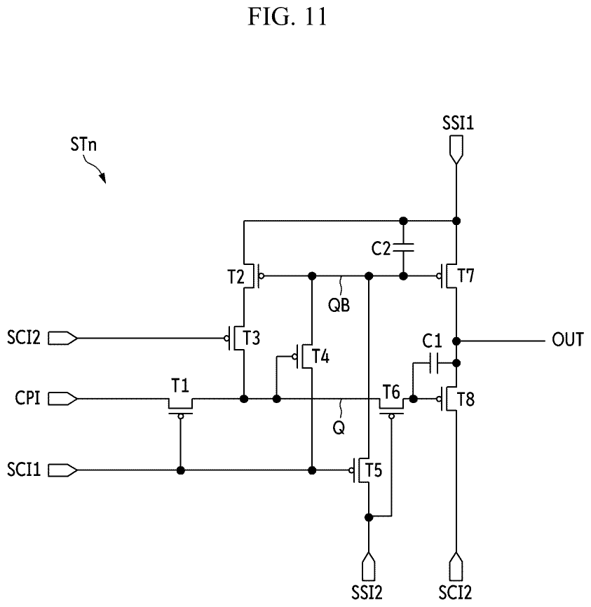

FIG. 11 is a detailed circuit diagram illustrating aspects of the (n−1)^{th} stage circuit of the scan driver 610 illustrated in FIG. 5. Although FIG. 6 illustrates various components in a stage according to some embodiments, embodiments according to the present disclosure are not limited thereto, and according to various embodiments, the stage may include additional components or fewer components without departing from the spirit and scope of embodiments according to the present disclosure.

For example, FIG. 11 illustrates an example of the (n−1)^{th} stage circuit STn−1 applied as a first stage circuit among the (n−1)^{th} through (n+1)^{th} stage circuits STn−1 through STn+1 of the scan driver 610.

As described above, the phase inversion circuit unit IVT may receive the output timing signal NST as a start signal generated and output in an opposite phase by the display driver 200, invert the phase of the output timing signal NST, and supply the output timing signal NST having the inverted phase to the (n−1)^{th} stage circuit STn−1, which is the first stage circuit, as the start timing signal IOU.

When the (n−1)^{th} stage circuit STn−1 is the first stage circuit, the output timing signal NST whose phase has been inverted by the phase inversion circuit unit IVT may be input as the start timing signal IOU to the previous carry terminal CPI of the (n−1)^{th} stage circuit STn−1.

The (n−1)^{th} stage circuit STn−1 includes an output node controller including first through sixth transistors T1 through T6 and first and second storage capacitors C1 and C2 and an output controller composed of seventh and eighth transistors T7 and T8. In addition, the (n−1)^{th} stage circuit STn−1 further includes the first power supply terminal SSI1 to which a gate-off voltage (e.g., a gate-low voltage) is supplied and the second power supply terminal SSI2 to which a gate-on voltage (e.g., a gate-low voltage) is supplied.

The (n−1)^{th} stage circuit STn−1 located as the first stage circuit operates in response to the start timing signal IOU input to the previous carry terminal CPI. In addition, each of the n^{th} stage circuit STn and the (n+1)^{th} stage circuit STn+1 may operate in response to a scan signal of an immediately previous stage circuit, which is dependently connected thereto, as a carry signal. An example in which the (n−1)^{th} stage circuit STn−1 of FIG. 11 is a stage circuit structured as the first stage circuit will be described below.

The output node controller of the (n−1)^{th} stage circuit STn−1 controls the gate-low voltage at the level of the gate-on voltage to be supplied to a pull-up node Q and a pull-down node QB during a first period (e.g., a charging period) of an active period of each frame period. At this time, the output controller including the seventh and eighth transistors T7 and T8 is enabled. During the first period of the active period, the pull-up node Q and the pull-down node QB are enabled at the level of the gate-on voltage, the gate-off voltage is applied to the seventh transistor T7 of the output controller, and the second scan clock signal CLK2 at the level of the gate-off voltage is transmitted to the eighth transistor T8. Accordingly, during the first period which is the charging period of the pull-up node Q, the gate-off voltage is output to the (n−1)^{th} scan signal line SCLn−1.

The output node controller of the (n−1)^{th} stage circuit STn−1 controls the pull-up node Q to be kept enabled and the pull-down node QB to be in a floating state or to be disabled by the gate-off voltage during a second period (e.g., a scan output period) of the active period of each frame period. Here, during the second period which is the scan output period, the second scan clock signal CLK2 at the level of the gate-on voltage is transmitted to the eighth transistor T8. Accordingly, the (n−1)^{th} scan signal SCn−1 at the level of the gate-on voltage is output to the (n−1)^{th} scan signal line SCLn−1 through the eighth transistor T8.

According to some embodiments, in the first period of the active period, the start timing signal IOU and the first scan clock signal CLK1 are supplied at the level of the gate-on voltage. Accordingly, the output node controller of the (n−1)^{th} stage circuit STn−1 enables the pull-up node Q and the pull-down node QB in response to the start timing signal IOU and the first scan clock signal CLK1 input during the first period of the active period and controls the gate-off voltage to be output to the (n−1)^{th} scan signal line SCLn−1. In the second period, the second scan clock signal CLK2 is supplied at the level of the gate-on voltage. Accordingly, in the second period, the output node controller keeps the pull-up node Q enabled in response to the second scan clock signal CLK2 and controls the (n−1)^{th} scan signal SCn−1 according to the second scan clock signal CLK2 to be output to the (n−1)^{th} scan signal line SCLn−1.

The seventh transistor T7 of the output controller is turned on when the pull-down node QB is enabled and outputs the gate-off voltage of the first power supply terminal SSI1 to the (n−1)^{th} scan signal line SCLn−1. Then, the seventh transistor T7 may be turned off when the pull-down node QB is floated or disabled.

The eighth transistor T8 of the output controller is turned on in the first period in which the pull-up node Q is enabled and supplies the gate-off voltage according to the second scan clock signal CLK2 to the (n−1)^{th} scan signal line SCLn−1. Then, in the second period in which the pull-down node QB is changed to the floating state and the seventh transistor T7 is turned off, the eighth transistor T8 supplies the gate-on voltage according to the second scan clock signal CLK2 to an (n−2)^{th} scan signal line SCLn−2 as the (n−1)^{th} scan signal SCn−1.

In this way, the (n−1)^{th} through (n+1)^{th} stage circuits STn−1 through STn+1 sequentially and repeatedly perform an operation of sequentially outputting scan signals to scan signal lines connected one-to-one thereto and then maintaining the scan signal lines at the gate-off voltage.

Each of the first through sixth transistors T1 through T6 of the output node controller included in each of the (n−1)^{th} through (n+1)^{th} stage circuits STn−1 through STn+1 includes first and second electrodes in addition to a gate electrode. Any one of the first and second electrodes may be a source electrode, and the other may be a drain electrode. The first storage capacitor C1 of the output node controller is formed to maintain a turn-on period of the eighth transistor T8, and the second storage capacitor C2 is formed to maintain a turn-on period of the seventh transistor T7.

The first transistor T1 of each of odd-numbered stage circuits among the (n−1)^{th} through (n+1)^{th} stage circuits STn−1 through STn+1 has the gate electrode connected to the first scan clock terminal SCI1, the first electrode connected to the previous carry terminal CPI, and the second electrode connected to the pull-up node Q. On the other hand, the first transistor T1 of each of even-numbered stage circuits among the (n−1)^{th} through (n+1)^{th} stage circuits STn−1 through STn+1 has the gate electrode connected to the second scan clock terminal SCI2.

The first transistor T1 of each of the odd-numbered stage circuits is turned on in response to the first scan clock signal CLK1 of the first scan clock terminal SCI1 and supplies the gate-on voltage according to the start timing signal IOU or previous scan signal of the previous carry terminal CPI to the pull-up node Q. On the other hand, the first transistor T1 of each of the even-numbered stage circuits is turned on in response to the second scan clock signal CLK2 of the second scan clock terminal SCI2 and supplies the gate-on voltage according to the previous scan signal of the previous carry terminal CPI to the pull-up node Q.

The second transistor T2 has the gate electrode connected to the pull-down node QB, the first electrode connected to the first power supply terminal SSI1, and the second electrode connected to the first electrode of the third transistor T3. The second transistor T2 is turned on when the pull-down node QB is enabled by the gate-on voltage and electrically connects the first power supply terminal SSI1 to the first electrode of the third transistor T3.

The third transistor T3 of each of the odd-numbered stage circuits among the (n−1)^{th} through (n+1)^{th} stage circuits STn−1 through STn+1 has the gate electrode connected to the second scan clock terminal SCI2, the first electrode connected to the second electrode of the second transistor T2, and the second electrode connected to the pull-up node Q. The third transistor T3 included in each of the odd-numbered stage circuits is turned on by the second scan clock signal CLK2 input to the second scan clock terminal SCI2 and electrically connects the second electrode of the second transistor T2 to the pull-up node Q. Accordingly, the third transistor T3 may electrically connect the pull-up node Q to the first power supply terminal SSI1 through the second transistor T2 in response to the second scan clock signal CLK2.

On the other hand, the third transistor T3 of each of the even-numbered stage circuits among the (n−1)^{th} through (n+1)^{th} stage circuits STn−1 through STn+1 has the gate electrode connected to the first scan clock terminal SCI1. Accordingly, the third transistor T3 included in each of the even-numbered stage circuits is turned on by the first scan clock signal CLK1 input to the first scan clock terminal SCI1 and electrically connects the second electrode of the second transistor T2 to the pull-up node Q.

The fourth transistor T4 has the gate electrode connected to the pull-up node Q, the first electrode connected to the first scan clock terminal SCI1, and the second electrode connected to the pull-down node QB. The fourth transistor T4 may be turned on when the pull-up node Q is enabled by the gate-on voltage and may electrically connect the first or second scan clock terminal SCI1 or SCI2 to the pull-down node QB. Accordingly, in the second period, the fourth transistor T4 may disable the pull-down node QB at the voltage level of the first or second scan clock terminal SCI1 or SCI2 or may change the pull-down node QB to the floating state. Only in the second period, the pull-down node QB is changed to the gate-off voltage, and the seventh transistor T7 is turned off.

The fifth transistor T5 of each of the odd-numbered stage circuits among the (n−1)^{th} through (n+1)^{th} stage circuits STn−1 through STn+1 has the gate electrode connected to the first scan clock terminal SCI1, the first electrode connected to the second power supply terminal SSI2, and the second electrode connected to the pull-down node QB. The fifth transistor T5 is turned on in response to the first scan clock signal CLK1 and electrically connects the second power supply terminal SSI2 to the pull-down node QB. Accordingly, the fifth transistor T5 may enable the pull-down node QB at the level of the gate-on voltage in response to the second scan clock signal CLK1.

On the other hand, the fifth transistor T5 of each of the even-numbered stage circuits among the (n−1)^{th} through (n+1)^{th} stage circuits STn−1 through STn+1 has the gate electrode connected to the second scan clock terminal SCI2. Accordingly, the fifth transistor T5 of each of the even-numbered stage circuits is turned on in response to the second scan clock signal CLK2 and electrically connects the second power supply terminal SSI2 to the pull-down node QB.

The sixth transistor T6 has the gate electrode connected to the second power supply terminal SSI2, the first electrode connected to the pull-up node Q, and the second electrode connected to the gate electrode of the eighth transistor T8 which operates as a pull-up transistor of the output controller. The sixth transistor T6 is turned on by the gate-on voltage input to the second power supply terminal SSI2 and electrically connects the pull-up node Q to the gate electrode of the eighth transistor T8.

The output controller of each of the (n−1)^{th} through (n+1)^{th} stage circuits STn−1 through STn+1 includes the seventh transistor T7 operating as a pull-down transistor and the eighth transistor T8 operating as a pull-up transistor.

The seventh transistor T7 operating as the pull-down transistor of the output controller has a gate electrode connected to the pull-down node QB, a first electrode connected to the first power supply terminal SSI1 to which the gate-off voltage is applied, and a second electrode connected to the scan output terminal SCO. Here, the second storage capacitor C2 controls the turn-on period of the seventh transistor T7.

The seventh transistor T7 is turned on during an enable period of the pull-down node QB and electrically connects the first power supply terminal SSI1 to the scan output terminal SCO. The seventh transistor T7 may transmit the gate-off voltage of the first power supply terminal SSI1 to the scan output terminal SCO during the turn-on period. Accordingly, the (n−1)^{th} scan signal line SCLn−1 connected to the scan output terminal SCO may be maintained at the gate-off voltage during the turn-on period of the seventh transistor T7.

The eighth transistor T8 operating as the pull-up transistor in the output controller of each of the odd-numbered stage circuits among the (n−1)^{th} through (n+1)^{th} stage circuits STn−1 through STn+1 has a gate electrode connected to the pull-up node Q by the sixth transistor T6 which is kept turned on. In addition, a first electrode is connected to the second scan clock terminal SCI2, and a second electrode is connected to the scan output terminal SCO.

The eighth transistor T8 of each of the odd-numbered stage circuits is turned on during an enable period in which the gate-on voltage is applied to the pull-up node QB and electrically connects the second scan clock terminal SCI2 to the scan output terminal SCO. The eighth transistor T8 may transmit the second scan clock signal CLK2, which is input to the second scan clock terminal SCI2, to the scan output terminal SCO during the turn-on period. Accordingly, the (n−1)^{th} scan signal SCn−1 at the level of the gate-on voltage may be supplied to the (n−1)^{th} scan signal line SCLn−1.

On the other hand, the eighth transistor T8 operating as the pull-up transistor in the output controller of each of the even-numbered stage circuits has the gate electrode connected to the first scan clock terminal SCI1 and the second electrode connected to the scan output terminal SCO. Accordingly, the eighth transistor T8 of each of the even-numbered stage circuits may be turned on during the enable period in which the gate-on voltage is applied to the pull-up node QB and may transmit the first scan clock signal CLK1 to the scan output terminal SCO.

Each of the first through eighth transistors T1 through T8 may be formed as a PMOS transistor. However, embodiments according to the present disclosure are not limited thereto, and each of the first through eighth transistors T1 through T8 may also be formed as an NMOS transistor.

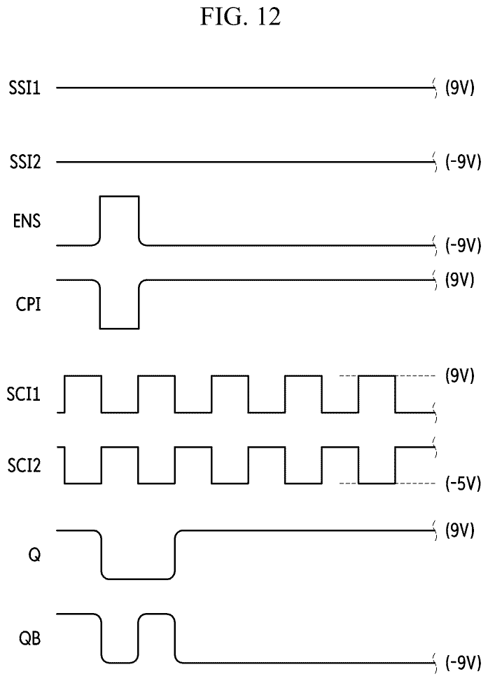

FIG. 12 is a waveform diagram illustrating changes in the voltage levels of gate control signals, scan clock signals, the pull-up node Q and the pull-down node QB during the active period of an n^{th} frame period.

Referring to FIGS. 11 and 12, in the first period of each horizontal line driving period of the active period for displaying an image through the pixels PX of the display area DA, the phase inversion circuit unit IVT inverts the phase of the output timing signal NST input to the timing control terminal ENS. Then, the phase inversion circuit unit IVT supplies the output timing signal NST having the inverted phase as the start timing signal IOU of the previous carry terminal CPI of the (n−1)^{th} stage circuit STn−1 which is the first stage circuit. Accordingly, in the first period of each horizontal line driving period, the start timing signal IOU or previous carry signal of the previous carry terminal CPI and the first scan clock signal CLK1 are supplied at the level of the gate-on voltage (e.g., −9 V).

The output node controller of the (n−1)^{th} stage circuit STn−1 controls the gate-low voltage at the level of the gate-on voltage to be supplied to the pull-up node Q and the pull-down node QB during the first period (e.g., the charging period) of the active period of each frame period. At this time, the output controller including the seventh and eighth transistors T7 and T8 is enabled. During the first period of the active period, the pull-up node Q and the pull-down node QB are enabled at the level of the gate-on voltage, the gate-off voltage is applied to the seventh transistor T7 of the output controller, and the second scan clock signal CLK2 at the level of the gate-off voltage is transmitted to the eighth transistor T8. Accordingly, during the first period which is the charging period of the pull-up node Q, the gate-off voltage is output to the (n−1)^{th} scan signal line SCLn−1.

The output node controller of the (n−1)^{th} stage circuit STn−1 controls the pull-up node Q to be kept enabled and the pull-down node QB to be in a floating state or to be disabled by the gate-off voltage during the second period (e.g., the scan output period) of the active period of each frame period. Here, during the second period which is the scan output period, the second scan clock signal CLK2 at the level of the gate-on voltage is transmitted to the eighth transistor T8. Accordingly, the (n−1)^{th} scan signal SCn−1 at the level of the gate-on voltage is output to the (n−1)^{th} scan signal line SCLn−1 through the eighth transistor T8.

The seventh transistor T7 of the output controller is turned on when the pull-down node QB is enabled and outputs the gate-off voltage of the first power supply terminal SSI1 to the (n−1)^{th} scan signal line SCLn−1. Then, the seventh transistor T7 may be turned off when the pull-down node QB is floated or disabled.

The eighth transistor T8 of the output controller is turned on in the first period in which the pull-up node Q is enabled and supplies the gate-off voltage according to the second scan clock signal CLK2 to the (n−1)^{th} scan signal line SCLn−1. Then, in the second period in which the pull-down node QB is changed to the floating state and the seventh transistor T7 is turned off, the eighth transistor T8 supplies the gate-on voltage according to the second scan clock signal CLK2 to the (n−2)^{th} scan signal line SCLn−2 as the (n−1)^{th} scan signal SCn−1.

In this way, the (n−1)^{th} through (n+1)^{th} stage circuits STn−1 through STn+1 sequentially and repeatedly perform an operation of sequentially outputting scan signals to scan signal lines connected one-to-one thereto and then maintaining the scan signal lines at the gate-off voltage.

As described above, the scan driver 610 according to some embodiments inverts the phase of the output timing signal NST such as a start signal among the gate control signals GCS and uses the output timing signal NST having the inverted phase as at least one gate control signal (e.g., the start timing signal IOU). Therefore, it may be possible to relatively reduce a difference in voltage level between gate control signals transmitted through adjacent signal pads and signal transmission lines. Accordingly, the electromagnetic interference between the gate control signals transmitted through the adjacent signal transmission lines can be relatively reduced, and signal distortion and defect occurrence due to the electromagnetic interference can be relatively reduced.

In addition, the signal pads and the signal transmission lines are rearranged to minimize the voltage level difference or phase difference between a gate control signal (e.g., the output timing signal NST) transmitted after its phase is inverted and other gate control signals. Therefore, the number of dummy pads and dummy lines can be reduced or zeroed. In addition, because the number of dummy pads or dummy lines is minimized, an image non-display area and a bezel area can be relatively reduced.

The display device according to some embodiments can be applied to various electronic devices. The electronic device according to some embodiments includes the display device described above and may further include modules or devices having additional functions in addition to the display device.

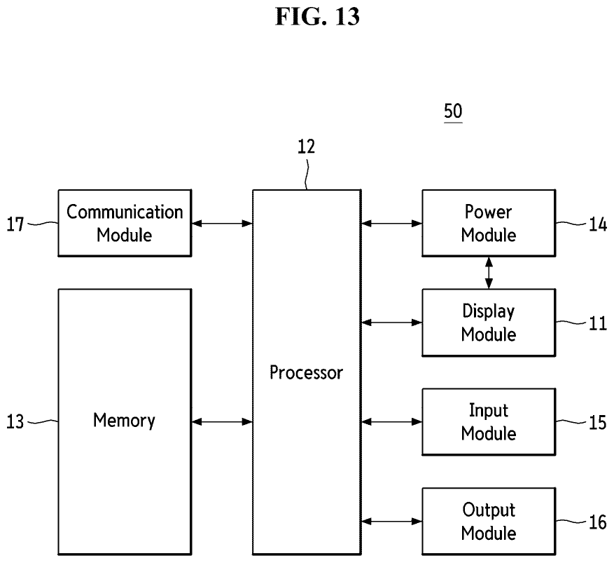

FIG. 13 is a block diagram of an electronic device according to some embodiments. Referring to FIG. 13, the electronic device 50 according to some embodiments may include a display module 11, a processor 12, a memory 13, and a power module 14. The electronic device 5000 may further include an input module 15, a non-image output module 16 and/or a communication module 17.

The electronic device 50 may output various information in the form of images through the display module 11. When the processor 12 executes an application stored in the memory 13, image information provided by the application may be provided to the user through the display module 11. The power module 14 may include a power supply module such as a power adapter or a battery device, and a power conversion module that converts the power supplied by the power supply module to generate power required for the operation of the electronic device 50. The input module 15 may provide input information to the processor 12 and/or the display module 11. The non-image output module 16 may receive information other than images transmitted from the processor 12, such as sound, haptics, and light, and provide the information to the user. The communication module 17 is a module that is responsible for transmitting and receiving information between the electronic device 50 and an external device, and may include a receiving unit and a transmitting unit.

At least one of the components of the electronic device 50 described above may be included in the display device according to the embodiments described above. In addition, some of the individual modules functionally included in one module may be included in the display device, and others may be provided separately from the display device. According to some embodiments, the display device includes a display module 11, and the processor 12, memory 13, and power module 14 may be provided in the form of other devices within the electronic device 50 other than the display device.

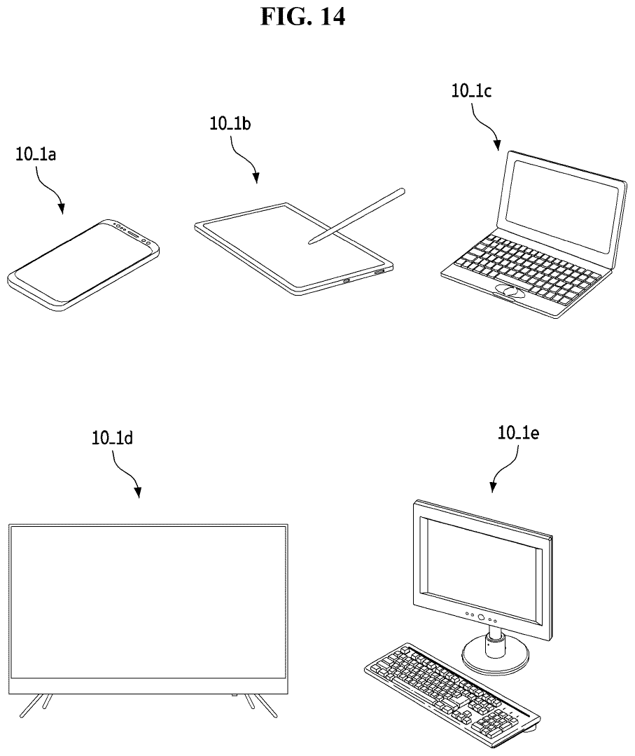

FIGS. 14, 15, and 16 are schematic diagrams of electronic devices according to various embodiments. FIGS. 14 to 16 illustrate examples of various electronic devices to which the display device according to the embodiments is applied.

FIG. 14 illustrates a smartphone 10_1a, a tablet PC 10_1b, a laptop 10_1c, a TV 10_1d, and a desk monitor 10_1e as examples of electronic devices.

In addition to the display module 11, the smartphone 10_1a may include an input module such as a touch sensor and a communication module. The smartphone 10_1a may process information received through the communication module or other input modules and display the information through the display module of the display device.

In the case of tablet PCs 10_1b, laptops 10_1c, TVs 10_1d, and desk monitors 10_1e, they also include display modules and input modules similar to smartphones 10_1, and may additionally include communication modules in some cases.

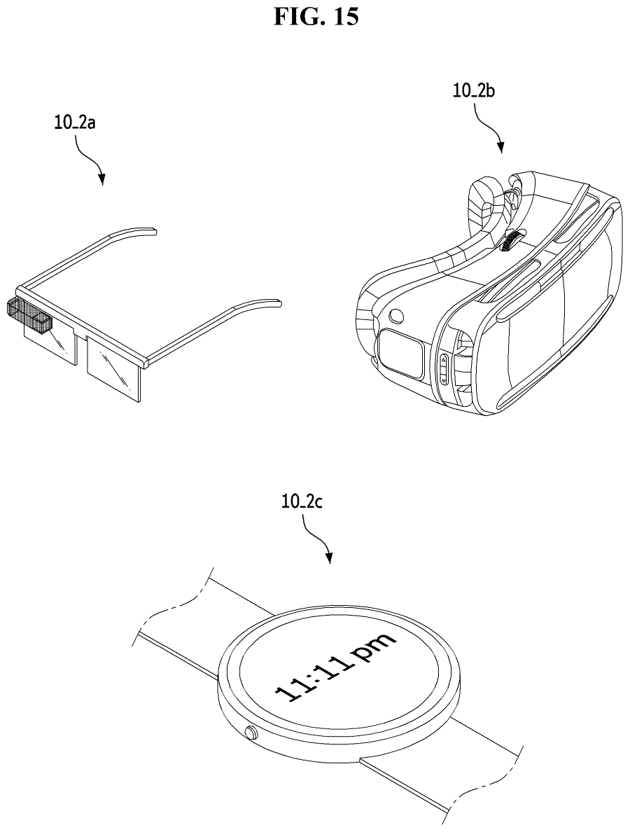

FIG. 15 shows an example of an electronic device including a display module being applied to a wearable electronic device. The wearable electronic device may be a smart glasses 10_2a, a head-mounted display 10_2b, a smart watch 10_2c, etc.

The smart glasses 10_2a and the head-mounted display 10_2b may include a display module that emits a display image and a reflector that reflects the emitted display screen and provides it to the user's eyes, thereby providing a virtual reality or augmented reality screen to the user.

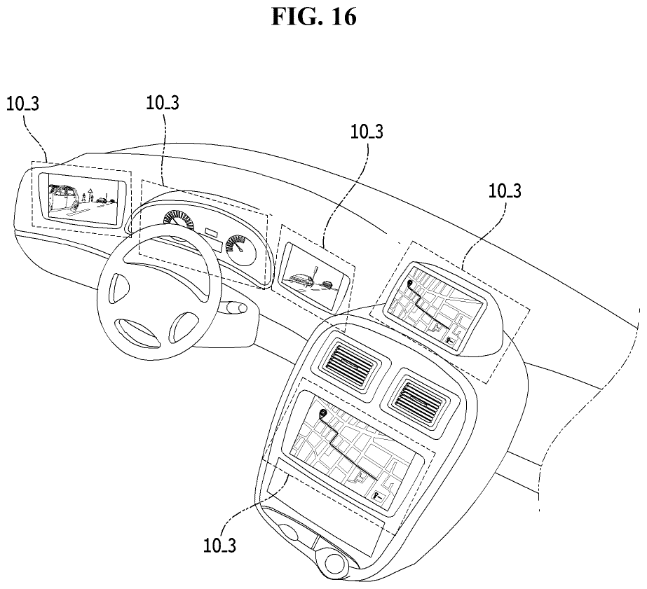

The smart watch 10_2c includes a biometric sensor as an input device, and may provide biometric information recognized by the biometric sensor to the user through the display module. FIG. 16 illustrates a case where an electronic device including a display module is applied to a vehicle. According to some embodiments, the electronic device 10_3 may be applied to a dashboard, center fascia, etc. of a vehicle, or may be applied to a CID (Center Information Display) placed on a dashboard of a vehicle, or a room mirror display replacing a side mirror.

In concluding the detailed description, those skilled in the art will appreciate that many variations and modifications can be made to the described embodiments without departing from the spirit and scope of embodiments according to the present disclosure. Therefore, the described embodiments of the present disclosure are used in a generic and descriptive sense only and not for purposes of limitation.

What is claimed is:

1. A scan driver comprising:
a plurality of signal pads configured to receive gate control signals from an external source;
a phase inversion circuit unit configured to invert a phase of at least one control signal in response to at least one other control signal among the gate control signals supplied through the signal pads, respectively, and to output the control signal having an inverted phase as an output timing signal; and
stage circuits configured to sequentially output scan signals to scan signal lines of an image display area based on the output timing signal and at least one of the gate control signals.

2. The scan driver of claim 1, wherein the phase inversion circuit unit is configured to invert the phase of at least one control signal input to a timing control terminal based on a line selection signal input through one of the signal pads and a sensing signal terminal and first and second inversion signals input to first and second inversion control terminals, respectively, and to transmit the control signal having the inverted phase as the output timing signal to at least one of the stage circuits through a timing signal output terminal.

3. The scan driver of claim 2, wherein the phase inversion circuit unit comprises:
a first switching element configured to output the output timing signal input to the timing control terminal based on the line selection signal input at a level of a gate-on voltage;
a second switching element configured to be turned on or off based on the output timing signal input through the first switching element and to supply a driving voltage at the level of the gate-on voltage to a first control node based on being turned on;
a third switching element configured to be turned on based on the driving voltage at the level of the gate-on voltage applied to the first control node and to output the driving voltage at the level of the gate-on voltage based on being turned on; and
a fourth switching element configured to be turned on or off based on the first inversion signal input to the first inversion control terminal and to output the driving voltage at the level of the gate-on voltage input through the third switching element to the timing signal output terminal based on being turned on.

4. The scan driver of claim 3, wherein the first, third and fourth switching elements are all formed as n-channel metal oxide semiconductor (NMOS) or p-channel metal oxide semiconductor (PMOS) transistors of a same type, and the second switching element is formed as a PMOS or NMOS transistor of a different type from the first, third and fourth switching elements.

5. The scan driver of claim 3, wherein the phase inversion circuit unit further comprises:
a fifth switching element configured to be turned on or off based on a voltage level of the output timing signal input through the first switching element and to supply a driving voltage at a level of a gate-off voltage to the first control node based on being turned on;
a sixth switching element configured to be turned on or off based on the voltage level of the output timing signal input to a second control node through the first switching element and to output the driving voltage at the level of the gate-off voltage to the timing signal output terminal or block the driving voltage at the level of the gate-off voltage; and
a seventh switching element configured to be turned on or off based on the second inversion signal input to the second inversion control terminal and to output the driving voltage at the level of the gate-off voltage to the timing signal output terminal based on being turned on.

6. The scan driver of claim 5, wherein the phase inversion circuit unit further comprises:
a first capacitor electrically connected between the first control node and a first power supply terminal configured to receive the driving voltage at the level of the gate-off voltage;
a second capacitor electrically connected between the second control node and the first power supply terminal; and
a third capacitor electrically connected between the timing signal output terminal and the first power supply terminal.

7. The scan driver of claim 2, wherein at least one of the stage circuits comprises:
an output node controller configured to supply the gate-on voltage to a pull-up node based on a phase-inverted output timing signal output from the timing signal output terminal of the phase inversion circuit unit and at least one of the gate control signals; and
an output controller configured to output a scan clock signal input to a scan clock terminal as a scan signal to each connected scan signal line based on the gate-on voltage being supplied to the pull-up node.

8. The scan driver of claim 7, wherein the output node controller comprises a first transistor configured to enable the pull-up node through the output timing signal input at a level of the gate-on voltage based on a first or second scan clock signal among the gate control signals, and the first transistor comprises a gate electrode connected to a first or second scan clock terminal, a first electrode connected to a carry terminal configured to receive the output timing signal, and a second electrode connected to the pull-up node.

9. A display device comprising:
a plurality of pixels in a display area of a display panel;
a touch sensing unit on a front of the display panel and integrally formed with the display panel;
a display driver configured to control data voltages supplied to the pixels and image display timing of the pixels; and
a scan driver configured to sequentially drive scan signal lines connected to the pixels based on gate control signals input from the display driver,
wherein the scan driver comprises:
a plurality of signal pads configured to receive the gate control signals;
a phase inversion circuit unit configured to invert a phase of at least one gate control signal based on at least one other gate control signal among the gate control signals and to output the gate control signal having an inverted phase as an output timing signal; and
stage circuits configured to sequentially output scan signals to the scan signal lines based on the output timing signal and the gate control signals.

10. The display device of claim 9, wherein the phase inversion circuit unit is configured to invert the phase of at least one control signal input to a timing control terminal based on a line selection signal input through one of the signal pads and a sensing signal terminal and first and second inversion signals input to first and second inversion control terminals, respectively, and to transmit the output timing signal to at least one of the stage circuits through a timing signal output terminal.

11. The display device of claim 10, wherein the phase inversion circuit unit comprises:
a first switching element configured to output the output timing signal input to the timing control terminal based on the line selection signal input at a level of a gate-on voltage;
a second switching element configured to be turned on or off based on the output timing signal input through the first switching element and to supply a driving voltage at the level of the gate-on voltage to a first control node when turned on;
a third switching element configured to be turned on based on the driving voltage at the level of the gate-on voltage applied to the first control node and to output the driving voltage at the level of the gate-on voltage based on being turned on; and
a fourth switching element configured to be turned on or off based on the first inversion signal input to the first inversion control terminal and to output the driving voltage at the level of the gate-on voltage input through the third switching element to the timing signal output terminal based on being turned on.

12. The display device of claim 11, wherein the first, third and fourth switching elements are all formed as NMOS or PMOS transistors of a same type, and the second switching element is formed as a PMOS or NMOS transistor of a different type from the first, third and fourth switching elements.

13. The display device of claim 11, wherein the phase inversion circuit unit further comprises:
a fifth switching element configured to be turned on or off based on a voltage level of the output timing signal input through the first switching element and to supply a driving voltage at a level of a gate-off voltage to the first control node based on being turned on;
a sixth switching element configured to be turned on or off based on the voltage level of the output timing signal input to a second control node through the first switching element and to output the driving voltage at the level of the gate-off voltage to the timing signal output terminal or to block the driving voltage at the level of the gate-off voltage; and
a seventh switching element configured to be turned on or off based on the second inversion signal input to the second inversion control terminal and to output the driving voltage at the level of the gate-off voltage to the timing signal output terminal based on being turned on.

14. The display device of claim 13, wherein the phase inversion circuit unit further comprises:
a first capacitor electrically connected between the first control node and a first power supply terminal configured to receive the driving voltage at the level of the gate-off voltage;
a second capacitor electrically connected between the second control node and the first power supply terminal; and
a third capacitor electrically connected between the timing signal output terminal and the first power supply terminal.

15. The display device of claim 10, wherein at least one of the stage circuits comprises:
an output node controller configured to supply the gate-on voltage to a pull-up node based on a phase-inverted output timing signal output from the timing signal output terminal of the phase inversion circuit unit and at least one of the gate control signals; and
an output controller configured to output a scan clock signal input to a scan clock terminal as a scan signal to each connected scan signal line based on the gate-on voltage being supplied to the pull-up node.

16. The display device of claim 15, wherein the output node controller comprises a first transistor configured to enable the pull-up node through the output timing signal input at the level of the gate-on voltage based on a first or second scan clock signal among the gate control signals, and the first transistor comprises a gate electrode connected to a first or second scan clock terminal, a first electrode connected to a carry terminal configured to receive the output timing signal, and a second electrode connected to the pull-up node.

17. An electronic device comprising:
a processor;
a memory connected to the processor; and
a display device connected to the processor,
wherein the display device comprising:
a plurality of pixels in a display area of a display panel;
a touch sensing unit on a front of the display panel and integrally formed with the display panel;
a display driver configured to control data voltages supplied to the pixels and image display timing of the pixels; and
a scan driver configured to sequentially drive scan signal lines connected to the pixels based on gate control signals input from the display driver,
wherein the scan driver comprises:
a plurality of signal pads configured to receive the gate control signals;
a phase inversion circuit unit configured to invert a phase of at least one gate control signal based on at least one other gate control signal among the gate control signals and to output the gate control signal having an inverted phase as an output timing signal; and
stage circuits configured to sequentially output scan signals to the scan signal lines based on the output timing signal and the gate control signals.

18. The display device of claim 17, wherein the phase inversion circuit unit is configured to invert the phase of at least one control signal input to a timing control terminal based on a line selection signal input through one of the signal pads and a sensing signal terminal and first and second inversion signals input to first and second inversion control terminals, respectively, and to transmit the output timing signal to at least one of the stage circuits through a timing signal output terminal.

19. The display device of claim 18, wherein the phase inversion circuit unit comprises:
a first switching element configured to output the output timing signal input to the timing control terminal based on the line selection signal input at a level of a gate-on voltage;
a second switching element configured to be turned on or off based on the output timing signal input through the first switching element and to supply a driving voltage at the level of the gate-on voltage to a first control node when turned on;
a third switching element configured to be turned on based on the driving voltage at the level of the gate-on voltage applied to the first control node and to output the driving voltage at the level of the gate-on voltage based on being turned on; and
a fourth switching element configured to be turned on or off based on the first inversion signal input to the first inversion control terminal and to output the driving voltage at the level of the gate-on voltage input through the third switching element to the timing signal output terminal based on being turned on.

20. The display device of claim 18, wherein at least one of the stage circuits comprises:
an output node controller configured to supply the gate-on voltage to a pull-up node based on a phase-inverted output timing signal output from the timing signal output terminal of the phase inversion circuit unit and at least one of the gate control signals; and
an output controller configured to output a scan clock signal input to a scan clock terminal as a scan signal to each connected scan signal line based on the gate-on voltage being supplied to the pull-up node.
